(19) United States
(12) Patent Application Publication
(10) Pub. No.: US 2024/0244535 A1
(43) Pub. Date: Jul. 18, 2024

(54) AUTONOMOUS VEHICLE REMOTE INITIALIZATION AND LOCATION SHARING

(71) Applicant: GM Cruise Holdings LLC, San Francisco, CA (US)

(72) Inventor: Joseph Brassard, Somerville, MA (US)

(21) Appl. No.: 18/153,563

(22) Filed: Jan. 12, 2023

(51) Int. Cl. H04W 52/28; H04W 4/02; H04W 4/40

(52) U.S. Cl. CPC H04W 52/283; H04W 4/025; H04W 4/40

(57) ABSTRACT

The present disclosure generally relates to autonomous vehicle (AV) initialization and, more specifically, to AV remote initialization and location sharing. In some aspects, the present disclosure provides a process for generating a power cycle event of an autonomous vehicle (AV) and determining if a position of the AV is indicated after the power cycle event for initializing the AV. In some aspects, the process can further include steps for receiving a second position from a wireless device if the position of the AV is not indicated after the power cycle event and initializing the AV based on the second position received from the wireless device. In some aspects, the wireless device can be an autonomous vehicle or a survey sensor.

### BACKGROUND

### 1. Technical Field

The present disclosure generally relates to autonomous vehicle (AV) initialization and, more specifically, to AV remote initialization and location sharing.

### 2. Introduction

An autonomous vehicle is a motorized vehicle that can navigate without a human driver. An exemplary autonomous vehicle can include various sensors, such as a camera sensor, a light detection and ranging (LiDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system for implementing AV remote initialization and location sharing, according to some examples of the present disclosure;

FIG. 2 illustrates an example of a communication process between a wireless device and an AV, according to some examples of the present disclosure;

FIG. 3 illustrates another example of a communication process between a wireless device and an AV, according to some examples of the present disclosure;

FIG. 4 illustrates an example of a process for implementing AV remote initialization and location sharing, according to some examples of the present disclosure;

FIG. 5 illustrates an example system environment that can be used to facilitate AV dispatch and operations, according to some aspects of the disclosed technology; and

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Autonomous vehicles (AVs), also known as self-driving cars, driverless vehicles, and robotic vehicles, are vehicles that use sensors to sense the environment and move without human input. Automation technology enables the AVs to drive on roadways and to perceive the surrounding environment accurately and quickly, including obstacles, signs, and traffic lights. In some cases, AVs can be used to pick up passengers and drive the passengers to selected destinations.

As discussed above, autonomous vehicles are designed to navigate autonomously in an environment without human input or intervention. In order to navigate autonomously, AVs may need to know their position (e.g., location/coordinates and orientation) within their environment and can utilize navigation sensors such as Global Navigation Satellite Systems (GNSS) receivers and Inertial Measurement Units (IMUs). For example, a Global Positioning System (GPS) receiver is a type of GNSS receiver that can receive geolocation and time information from GPS satellites. The GPS receiver can provide an AV numerical coordinates (e.g., latitude, longitude) representing the AV's physical location in space. For example, an AV may need decimeter-level navigation and location accuracy provided by a GPS receiver to safely stay in the correct lane. In some cases, there may be obstacles preventing the GPS receiver from receiving a signal from GPS satellites. For example, there can be tall buildings that block a direct view of the sky. In another example, there may be weather conditions such as a storm causing an obstructed view of the satellites or radio frequency (RF) interference from other signals. Those skilled in the art will appreciate additional examples of scenarios where a GPS signal is not received by a GPS receiver. If the AV is unable to make a determination of its position, then another vehicle (e.g., manually driven vehicle) may need to navigate to the AV for servicing. For example, the AV may need to be manually driven by a technician to a depot for servicing. This may require taking the AV out of service for extended periods of time.

Aspects of the disclosed invention provide solutions for autonomous vehicle remote initialization and location sharing. For example, if an AV is unable to determine its position, then another wireless device can share position information to help the AV initialize. In some aspects, as described herein, the initialization of the AV can be determining its position which can include its location (e.g., coordinates such as latitude and longitude) and its orientation in the environment (e.g., the environment the AV is autonomously driving in). In one example, the wireless device may be a second AV. In some cases, the AV that is unable to initialize can receive the GNSS location of the second AV. The AV may use its sensors (e.g., LiDAR, RADAR, camera) to determine the distance offset of the second AV (e.g., the distance between the AV and the second

AV). Since the AV knows the location of the second AV and the distance offset, the AV may calculate its own location. In addition, the AV may use its sensors to determine an orientation offset by analyzing the orientation of the second AV. In other words, the AV may calculate its own orientation by analyzing (e.g., with sensors) the orientation of the second AV. In another example, the second AV may determine a position offset with the first AV and consequently calculate the position of the AV. As described herein, position offset can include distance offset and orientation offset, or the difference in location and orientation between the AV and second AV (e.g., the AV that cannot initialize and the second AV that is assisting). The second AV may then share this position information with the AV (e.g., in this example, the second AV determines and shares the position of the AV instead of the AV determining its own position using the location of the second AV). In another example, the wireless device may be a survey sensor, such as a fixed point survey sensor attached to a physical structure including, but not limited to, a building or streetlight.

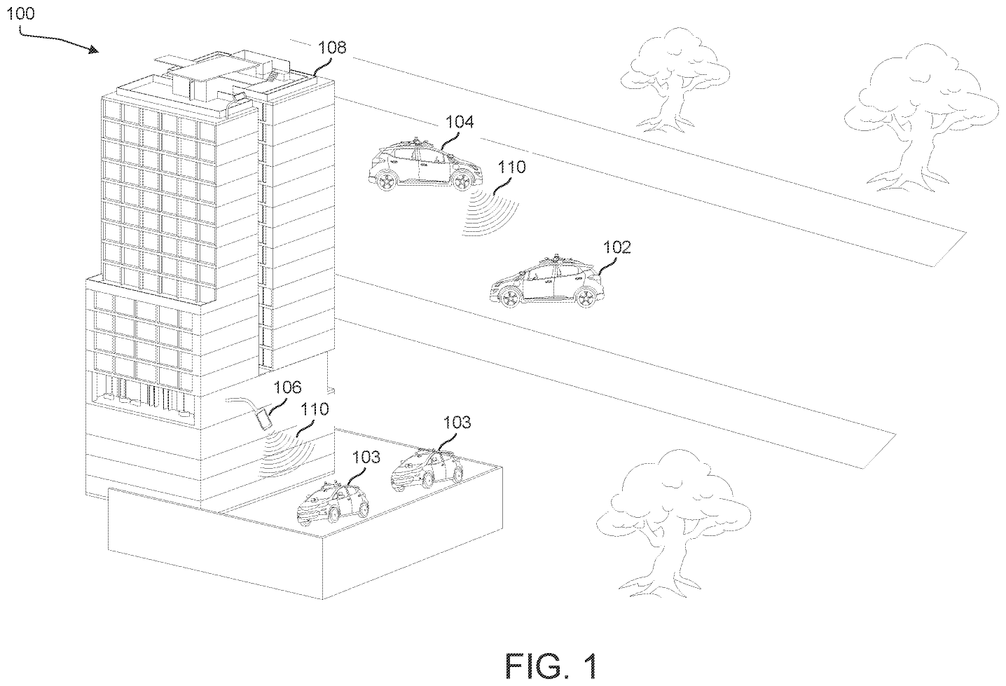

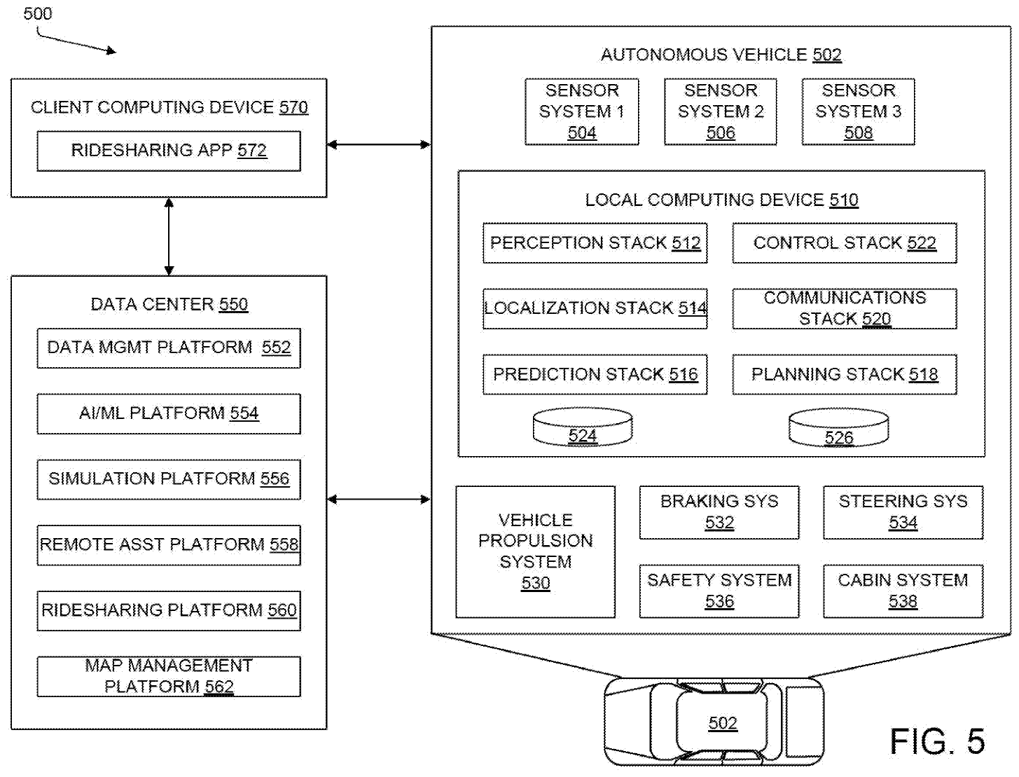

FIG. 1 illustrates an example of a scenario 100 in which an AV remote initialization and location sharing process may be implemented. Scenario 100 includes a first AV 102, one or more fleet AVs 103, a second AV 104, survey sensor 106, structure 108, and RF signal 110. The scenario 100 may include a real-world environment in which first AV 102, fleet AV 103, and second AV 104 are able to drive autonomously. The first AV 102 may be an autonomous vehicle that is unable to initialize (e.g., unable to determine a location and/or orientation) in scenario 100. For example, first AV 102 may include sensors (e.g., sensors 504, 506 and 508 as illustrated in FIG. 5) including a GPS receiver that enables first AV 102 to determine its location (e.g., latitude and longitude coordinates) in scenario 100. In some aspects, first AV 102 may lose GPS connection and consequently will be unable to determine its respective coordinates (e.g., latitude and longitude) within scenario 100. In addition, first AV 102 may have additional technical issues with its sensors and consequently be unable to determine its orientation within scenario 100. As a result of first AV 102 not being able to initialize, this may cause first AV 102 to be disabled from driving autonomously. First AV 102 may attempt a power cycle event (e.g., restart by turning itself off and then on again) to correct the one or more technical issues with its sensors (e.g., the GPS receiver not receiving a satellite signal, the LiDAR not functioning, etc.).

If first AV 102 is unable to correct the one or more technical issues and consequently is unable to initialize, then another second AV 104 may approach first AV 102 for assistance. For example, second AV 104 may be another autonomous vehicle (e.g., either the same or a different make and model) that may navigate to first AV 102 if first AV 102 transmits a signal (e.g., RF signal 110) requesting assistance. In other words, first AV 102 may transmit a signal indicating a request for assistance to a remote server or terminal that second AV 104 is able to communicate with (e.g., transmit and receive data). In another example, second AV 104 may be within vicinity of first AV 102. In other words, second AV 104 can see first AV 102 with its sensors (e.g., LiDAR, RADAR, camera) and may receive a signal (e.g., via communications stack 520 as illustrated in FIG. 5) indicating a request for assistance. In another example, second AV 104 may be able to determine first AV 102 requires assistance without receiving a signal from first AV 102. First AV 102 and second AV 104 may communicate with one another via RF signal 110. Examples of RF signal 110 types may include, but are not limited to, Ultra-Wideband (UWB), Vehicle-to-Vehicle (V2V), millimeter wave (mmWave), Li-Fi, cellular, WIFI, Wireless Local Area Network (WLAN), Low Power Wide Area Network (LPWAN), Bluetooth®, satellite-based (e.g., Starlink, Kuiper Systems, Globalstar, Viasat, Echostar), and infrared. Those skilled in the art will appreciate additional examples of vehicle-to-vehicle communication methods.

In some examples, second AV 104 may transmit its location (e.g., latitude and longitude of second AV 104) to first AV 102. In other words, second AV 104 may transmit its coordinates (e.g., received by its GPS receiver) to first AV 102. First AV 102 may then use one or more of its sensors and local computing device (e.g., LiDAR, RADAR, camera such as sensor systems 504, 506, and 508 along with local computing device 510 as illustrated in FIG. 5) to calculate a distance to second AV 104. In other words, first AV 102 can determine a distance between itself and second AV 104. Since first AV 102 received the coordinates of second AV 104 and knows the distance to second AV 104, then AV 102 may calculate its own location or coordinates within scenario 100. In addition, in order to initialize first AV 102 may also need to determine its orientation or pose within scenario 100 (e.g., the direction first AV 102 is pointing). In one example, first AV 102 may calculate its orientation from its IMU, specifically the gyroscope data within its IMU (e.g., performing the mathematical operation of an integral of the angular velocity of the gyroscope data which can determine the orientation). In another example, first AV 102 may use one or more of its sensors (e.g., LiDAR, RADAR, camera) to analyze the orientation of second AV 104 to calculate its own orientation. In some examples, second AV 104 may calculate the position of first AV 102 and transmit the calculation to first AV 102. For example, second AV 104 can calculate a distance to first AV 102 (e.g., using its sensors and local computing device). Next, since second AV 104 knows its own location from its GPS receiver and the distance to first AV 102, it can calculate a location (e.g., coordinates or latitude and longitude) of first AV 102. In another example, second AV 104 may use its prediction stack (e.g., prediction stack 516 as illustrated in FIG. 5) to estimate a location of first AV 102. In addition, second AV 104 may determine the orientation of first AV 102 using one or more of its sensors. For example, second AV 104 may use its camera sensor to determine the orientation of first AV 102. As a result, second AV 104 can transmit at least one of a location of first AV 102, an orientation of first AV 102, or a combination thereof. In some aspects, there may be one or more first AVs 102 that can receive assistance from one or more second AVs 104.

In some instances, there can be a survey sensor 106 that can transmit position information to first AV 102. Survey sensor 106 may be attached at a fixed point location to a structure 108. Examples of structure 108 may include, but are not limited to, a building, parking structure, and streetlight. Those skilled in the art will appreciate additional examples of structure 108 that may be used as a fixed point location to attach survey sensor 106. In some aspects, survey sensor 106 may include hardware and software that is also in second AV 104 that enables survey sensor 106 to determine its own location (e.g., a GPS receiver to determine its coordinates) along with sensors (e.g., LiDAR, camera, RADAR) to perceive and analyze an autonomous vehicle. In some examples, survey sensor 106 may have stored pre-determined coordinates for its location and a pre-determined orientation (e.g., a land surveyor or technician can determine the coordinates and orientation of survey sensor 106 which can be stored on survey sensor 106). In addition, survey sensor 106 may include a communication system that enables communication via an RF signal 100. As illustrated in FIG. 1, there may be one or more fleet AVs 103 that are unable to initialize. In other words, fleet AV 103 may be unable to determine at least one of its location, its orientation, or a combination thereof as described above with respect to first AV 102. For example, fleet AV 103 may be inside a building or parking structure preventing fleet AV 103 from receiving a GPS satellite signal. The survey sensor 106 may determine its location (e.g., from its GPS receiver) and calculate a location (e.g., using a local computing device and sensors such as LiDAR, RADAR, and camera) of fleet AV 103. This calculation may be similar to the calculation as described above with respect to second AV 104 and first AV 102. In addition, survey sensor 106 may determine an orientation of fleet AV 103 from one or more of its sensors. The survey sensor 106 may then transmit (e.g., via its communication system and RF signal 110) the position information of fleet AV 103 to fleet AV 103. The position information may include at least one of fleet AV's 103 location, fleet AV's 103 orientation, or a combination thereof. In some cases, survey sensor 106 may initialize (e.g., transmit position information) one or more fleet AVs 103 (e.g., there may be more than one fleet AV 103 uninitialized within structure 108).

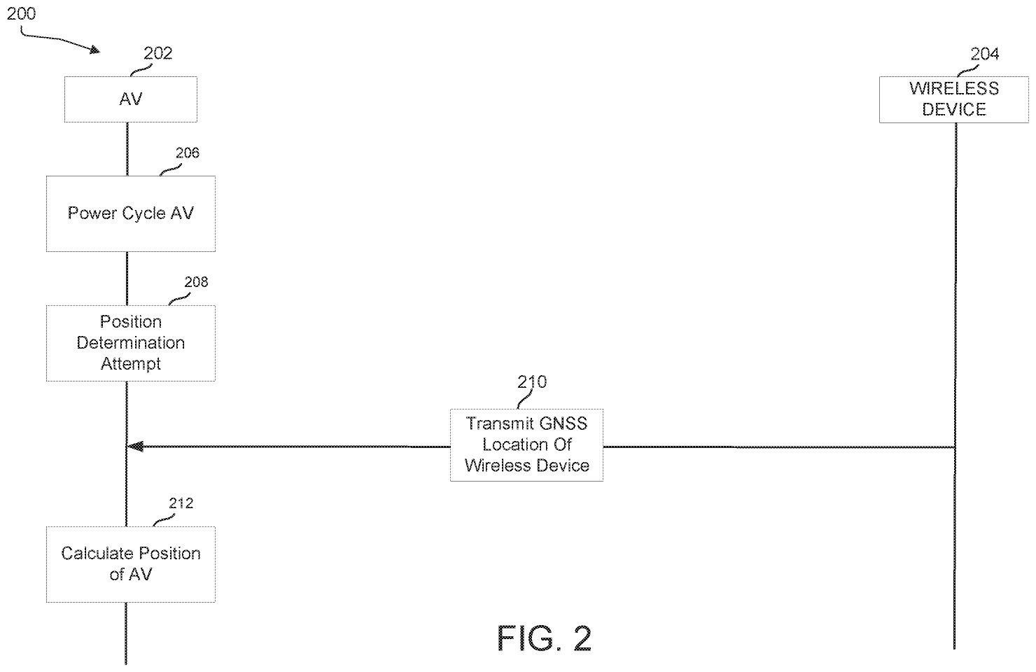

FIG. 2 illustrates an example of a communication process 200 between a wireless device 204 and an AV 202, according to some examples of the present disclosure. The process 200 begins with step 206 where AV 202 performs a power cycle event. For example, AV 202 may be unable to initialize or determine its position in the environment. As a result, AV 202 may perform a power cycle event turning AV 202 off followed by turning AV 202 on to potentially resolve the issue of determining a position.

Next, the process 200 moves to step 208 where AV 202 attempts to determine its position. In other words, after AV 202 performs a power cycle in step 206, AV 202 re-attempts to determine its position in the environment. If AV 202 is still unable to determine its position, it can turn off and consequently disable itself from navigating autonomously. In some cases, AV 202 may transmit a signal (e.g., a distress signal) indicating it is unable to navigate autonomously or that it is having technical issues. Next, the process 200 continues to step 210 where a wireless device 204 transmits its GNSS location. In some examples, wireless device 204 may be a survey sensor attached to a fixed point location such as in a parking garage, building, or a streetlight. In other examples, wireless device can be another AV. The wireless device 204 can include a GNSS receiver such as a GPS receiver capable of determining the coordinates of wireless device 204. In step 210, the wireless device transmits its coordinates such as latitude and longitude to AV 202. Next, the process 200 continues to step 212 where AV 202 calculates a position. After receiving coordinates of wireless device 204, AV 202 may use one or more of its sensors to determine a distance between AV 202 and wireless device 204. For example, AV 202 may include a LiDAR sensor capable of determining the distance to wireless device 204 (e.g., the distance between AV 202 and wireless device 204). Since AV 202 knows the coordinates of wireless device 204 and the distance to wireless device 204, then AV 202 may calculate its own coordinates (e.g., location or latitude and longitude) in the environment. In some instances, AV 202 may also use one or more of its sensors to determine the orientation of AV 202. For example, AV 202 may analyze the orientation of wireless device 204 to determine its own orientation.

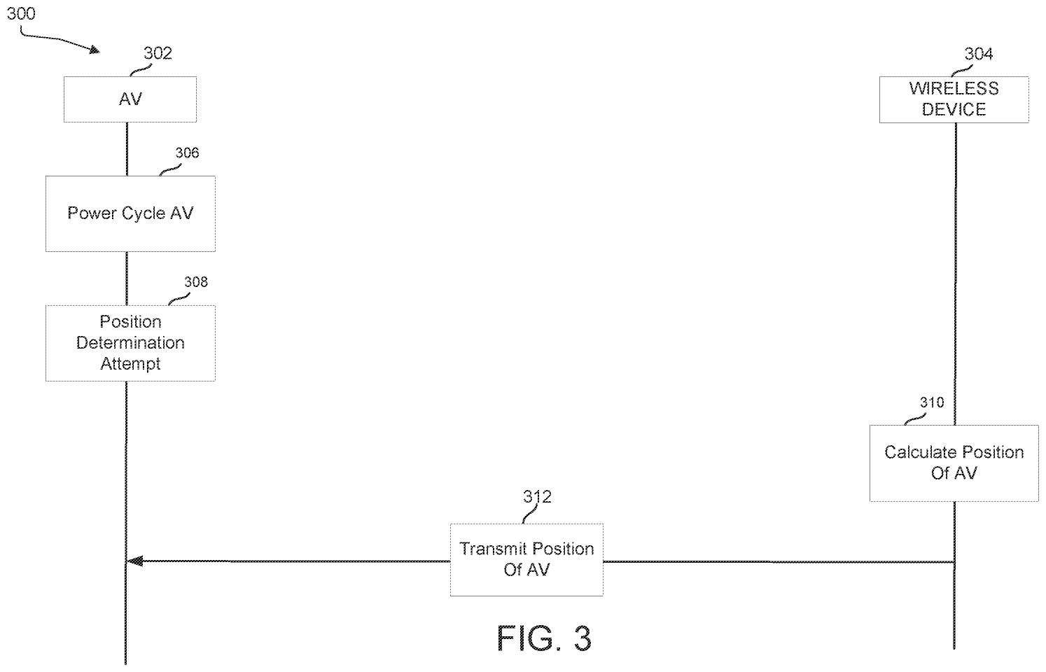

FIG. 3 illustrates another example of a communication process 300 between a wireless device 304 and an AV 302, according to some examples of the present disclosure. The steps 306 and 308 in process 300 are as described above in steps 206 and 208, respectively, in process 200 of FIG. 2. In addition, AV 302 and wireless device 304 are as described above in FIG. 2 with AV 202 and wireless device 204, respectively. The process 300 then continues to step 310 where wireless device 304 calculates a position of AV 302. For example, a wireless device 304 (e.g., survey sensor or another AV) can use its sensors to calculate a distance to AV 302. In other words, wireless device 304 can calculate the distance between wireless device 304 and AV 302. Since wireless device 304 knows its own location from its GPS receiver and the distance to AV 302, it can calculate the location or coordinates of AV 302. In some cases, wireless device 304 way use its prediction stack (e.g., prediction stack 516 as illustrated in FIG. 5) to estimate a location of AV 302. In addition, wireless device 304 may use one or more of its sensors to determine the orientation of AV 302. For example, the camera of wireless device 304 can analyze the orientation of AV 302. Next, the process 300 continues to step 312 where wireless device 304 transmits the position of AV 302 to AV 302 (e.g., at least one of the location of AV 302, the orientation of AV 302, or a combination thereof).

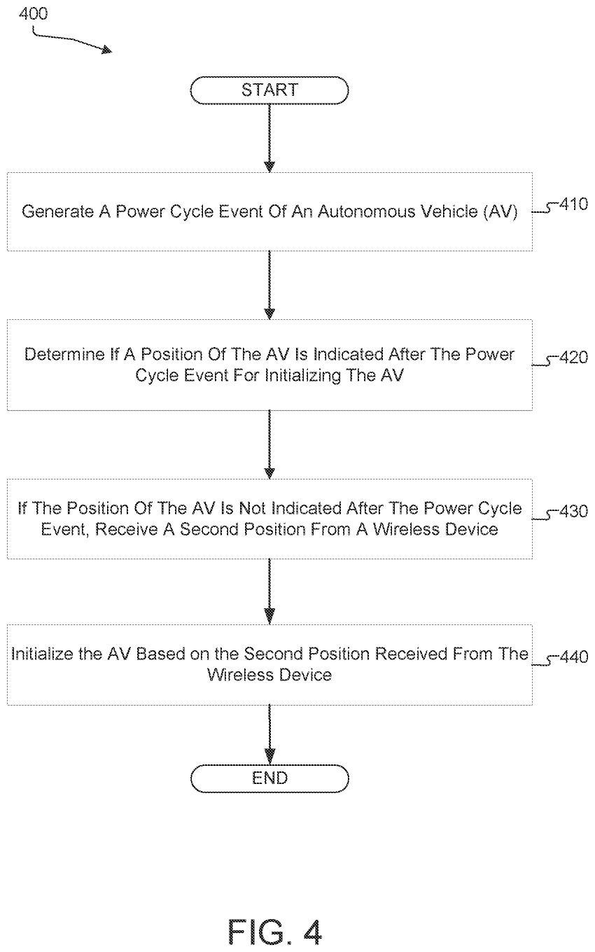

FIG. 4 illustrates an example of a process 400 for implementing AV remote initialization and location sharing. At block 410, the process 400 includes generating a power cycle event of an autonomous vehicle. For example, first AV 102 or fleet AV 103 may power cycle or restart (e.g., turn off and then turn on) to initialize. In other words, first AV 102 or fleet AV 103 can power cycle to determine their position in the environment, such as scenario 100.

At block 420, the process 400 includes determining if a position of the AV is indicated after the power cycle event for initializing the AV. For example, after generating a power cycle event in block 410, first AV 102 or fleet AV 103 can attempt to determine if a position is indicated or known. In other words, first AV 102 or fleet AV 103 can determine if their coordinates (e.g., latitude and longitude) are known within scenario 100. In addition, first AV 102 or fleet AV 103 can determine if their orientation is known within scenario 100.

At block 430, if the position of the AV is not indicated after the power cycle event, the process 400 includes receiving a second position from a wireless device. For example, first AV 102 can receive a second position from a wireless device, such as second AV 104. In some instances, the second position can be the position of second AV 104 which can include the latitude and longitude of second AV 104. In some aspects, the second position can be the position of first AV 102 which can include at least one of the latitude, longitude, orientation or a combination thereof of first AV 102.

At block 440, the AV is initialized based on the second position received from the wireless device. For example, if the second position includes the position of first AV 102 itself, then first AV 102 can be initialized directly from the second position. In another example, if the second position includes a position of a neighboring AV such as second AV 104, then first AV 102 can calculate its own position based on the second position and use its own position to initialize. Initialization can include performing applicable steps for initializing the AV to continue operation based on its known position.

In some examples, the wireless device can be survey sensor. For example, fleet AV 103 can receive a position from survey sensor 106. In some examples, the survey sensor is attached to a fixed point location. For example, survey sensor 106 may be attached to a fixed point location such as a structure 108 which can be a building as illustrated in FIG. 1 or a streetlight. In some examples, the position comprises at least one of a latitude, a longitude, an orientation, or a combination thereof. For example, the position of AV 102 can include at least one of its latitude, longitude, orientation, or a combination thereof. In some examples, the second position comprises at least one of a latitude of the wireless device, a longitude of the wireless device, or a combination thereof. For example, the second position can include at least one of a latitude, a longitude, or a combination thereof of second AV 104 or survey sensor 106. In some examples, the second position comprises at least one of a latitude of the AV, a longitude of the AV, an orientation of the AV, or a combination thereof. For example, the second position can include at least one of a latitude, a longitude, an orientation, or a combination thereof of first AV 102 or fleet AV 103.

FIG. 5 is a diagram illustrating an example AV environment 500, according to some examples of the present disclosure. One of ordinary skill in the art will understand that, for the AV management system 500 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV management system 500 includes an AV 502, a data center 550, and a client computing device 570. The AV 502, the data center 550, and the client computing device 570 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 502 can navigate roadways without a human driver based on sensor signals generated by multiple sensor systems 504, 506, and 508. The sensor systems 504-508 can include one or more types of sensors and can be arranged about the AV 502. For instance, the sensor systems 504-508 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 504 can be a camera system, the sensor system 506 can be a LIDAR system, and the sensor system 508 can be a RADAR system. Other examples may include any other number and type of sensors.

The AV 502 can also include several mechanical systems that can be used to maneuver or operate the AV 502. For instance, the mechanical systems can include a vehicle propulsion system 530, a braking system 532, a steering system 534, a safety system 536, and a cabin system 538, among other systems. The vehicle propulsion system 530 can include an electric motor, an internal combustion engine, or both. The braking system 532 can include an engine brake, brake pads, actuators, and/or any other suitable componentry configured to assist in decelerating the AV 502. The steering system 534 can include suitable componentry configured to control the direction of movement of the AV 502 during navigation. The safety system 536 can include lights and signal indicators, a parking brake, airbags, and so forth. The cabin system 538 can include cabin temperature control systems, in-cabin entertainment systems, and so forth. In some examples, the AV 502 might not include human driver actuators (e.g., steering wheel, handbrake, foot brake pedal, foot accelerator pedal, turn signal lever, window wipers, etc.) for controlling the AV 502. Instead, the cabin system 538 can include one or more client interfaces (e.g., Graphical User Interfaces (GUIs), Voice User Interfaces (VUIs), etc.) for controlling certain aspects of the mechanical systems 530-538.

The AV 502 can include a local computing device 510 that is in communication with the sensor systems 504-508, the mechanical systems 530-538, the data center 550, and the client computing device 570, among other systems. The local computing device 510 can include one or more processors and memory, including instructions that can be executed by the one or more processors. The instructions can make up one or more software stacks or components responsible for controlling the AV 502; communicating with the data center 550, the client computing device 570, and other systems; receiving inputs from riders, passengers, and other entities within the AV's environment; logging metrics collected by the sensor systems 504-508; and so forth. In this example, the local computing device 510 includes a perception stack 512, a localization stack 514, a prediction stack 516, a planning stack 518, a communications stack 520, a control stack 522, an AV operational database 524, and an HD geospatial database 526, among other stacks and systems.

The perception stack 512 can enable the AV 502 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 504-508, the localization stack 514, the HD geospatial database 526, other components of the AV, and other data sources (e.g., the data center 550, the client computing device 570, third party data sources, etc.). The perception stack 512 can detect and classify objects and determine their current locations, speeds, directions, and the like. In addition, the perception stack 512 can determine the free space around the AV 502 (e.g., to maintain a safe distance from other objects, change lanes, park the AV, etc.). The perception stack 512 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The localization stack 514 can determine the AV's position and orientation (pose) using different methods from multiple systems (e.g., GPS, IMUs, cameras, LIDAR, RADAR, ultrasonic sensors, the HD geospatial database 526, etc.). For example, in some cases, the AV 502 can compare sensor data captured in real-time by the sensor systems 504-508 to data in the HD geospatial database 526 to determine its precise (e.g., accurate to the order of a few centimeters or less) position and orientation. The AV 502 can focus its search based on sensor data from one or more first sensor systems (e.g., GPS) by matching sensor data from one or more second sensor systems (e.g., LIDAR). If the mapping and localization information from one system is unavailable, the AV 502 can use mapping and localization information from a redundant system and/or from remote data sources.

The prediction stack 516 can receive information from the localization stack 514 and objects identified by the perception stack 512 and predict a future path for the objects. In some examples, the prediction stack 516 can output several likely paths that an object is predicted to take along with a probability associated with each path. For each predicted path, the prediction stack 516 can also output a range of points along the path corresponding to a predicted location of the object along the path at future time intervals along with an expected error value for each of the points that indicates a probabilistic deviation from that point.

The planning stack 518 can determine how to maneuver or operate the AV 502 safely and efficiently in its environment. For example, the planning stack 518 can receive the location, speed, and direction of the AV 502, geospatial data, data regarding objects sharing the road with the AV 502 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 502 from one point to another and outputs from the perception stack 512, localization stack 514, and prediction stack 516. The planning stack 518 can determine multiple sets of one or more mechanical operations that the AV 502 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 518 can select from multiple backup plans to carry out. For example, while preparing to change lanes to turn right at an intersection, another vehicle may aggressively cut into the destination lane, making the lane change unsafe. The planning stack 518 could have already determined an alternative plan for such an event. Upon its occurrence, it could help direct the AV 502 to go around the block instead of blocking a current lane while waiting for an opening to change lanes.

The control stack 522 can manage the operation of the vehicle propulsion system 530, the braking system 532, the steering system 534, the safety system 536, and the cabin system 538. The control stack 522 can receive sensor signals from the sensor systems 504-508 as well as communicate with other stacks or components of the local computing device 510 or a remote system (e.g., the data center 550) to effectuate operation of the AV 502. For example, the control stack 522 can implement the final path or actions from the multiple paths or actions provided by the planning stack 518. This can involve turning the routes and decisions from the planning stack 518 into commands for the actuators that control the AV's steering, throttle, brake, and drive unit.

The communications stack 520 can transmit and receive signals between the various stacks and other components of the AV 502 and between the AV 502, the data center 550, the client computing device 570, and other remote systems. The communications stack 520 can enable the local computing device 510 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 520 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 526 can store HD maps and related data of the streets upon which the AV 502 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 524 can store raw AV data generated by the sensor systems 504-508, stacks 512-522, and other components of the AV 502 and/or data received by the AV 502 from remote systems (e.g., the data center 550, the client computing device 570, etc.). In some examples, the raw AV data can include HD LIDAR point cloud data, image data, RADAR data, GPS data, and other sensor data that the data center 550 can use for creating or updating AV geospatial data or for creating simulations of situations encountered by AV 502 for future testing or training of various machine learning algorithms that are incorporated in the local computing device 510.

The data center 550 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 550 can include one or more computing devices remote to the local computing device 510 for managing a fleet of AVs and AV-related services. For example, in addition to managing the AV 502, the data center 550 may also support a ridesharing service, a delivery service, a remote/roadside assistance service, street services (e.g., street mapping, street patrol, street cleaning, street metering, parking reservation, etc.), and the like.

The data center 550 can send and receive various signals to and from the AV 502 and the client computing device 570. These signals can include sensor data captured by the sensor systems 504-508, roadside assistance requests, software updates, ridesharing pick-up and drop-off instructions, and so forth. In this example, the data center 550 includes a data management platform 552, an Artificial Intelligence/Machine Learning (AI/ML) platform 554, a simulation platform 556, a remote assistance platform 558, and a ridesharing platform 560, and a map management platform 562, among other systems.

The data management platform 552 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 550 can access data stored by the data management platform 552 to provide their respective services.

The AI/ML platform 554 can provide the infrastructure for training and evaluating machine learning algorithms for operating the AV 502, the simulation platform 556, the remote assistance platform 558, the ridesharing platform 560, the map management platform 562, and other platforms and systems. Using the AI/ML platform 554, data scientists can prepare data sets from the data management platform 552; select, design, and train machine learning models; evaluate, refine, and deploy the models; maintain, monitor, and retrain the models; and so on.

The simulation platform 556 can enable testing and validation of the algorithms, machine learning models, neural networks, and other development efforts for the AV 502, the remote assistance platform 558, the ridesharing platform 560, the map management platform 562, and other platforms and systems. The simulation platform 556 can replicate a variety of driving environments and/or reproduce real-world scenarios from data captured by the AV 502, including rendering geospatial information and road infrastructure (e.g., streets, lanes, crosswalks, traffic lights, stop signs, etc.) obtained from a cartography platform (e.g., map management platform 562); modeling the behavior of other vehicles, bicycles, pedestrians, and other dynamic elements; simulating inclement weather conditions, different traffic scenarios; and so on.

The remote assistance platform 558 can generate and transmit instructions regarding the operation of the AV 502. For example, in response to an output of the AI/ML platform 554 or other system of the data center 550, the remote assistance platform 558 can prepare instructions for one or more stacks or other components of the AV 502.

The ridesharing platform 560 can interact with a customer of a ridesharing service via a ridesharing application 572 executing on the client computing device 570. The client computing device 570 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridesharing application 572. The client computing device 570 can be a customer's mobile computing device or a computing device integrated with the AV 502 (e.g., the local computing device 510). The ridesharing platform 5160 can receive requests to pick up or drop off from the ridesharing application 5172 and dispatch the AV 5102 for the trip.

Map management platform 562 can provide a set of tools for the manipulation and management of geographic and spatial (geospatial) and related attribute data. The data management platform 552 can receive LIDAR point cloud data, image data (e.g., still image, video, etc.), RADAR data, GPS data, and other sensor data (e.g., raw data) from one or more AVs 502, Unmanned Aerial Vehicles (UAVs), satellites, third-party mapping services, and other sources of geospatially referenced data. The raw data can be processed, and map management platform 562 can render base representations (e.g., tiles (2D), bounding volumes (3D), etc.) of the AV geospatial data to enable users to view, query, label, edit, and otherwise interact with the data. Map management platform 562 can manage workflows and tasks for operating on the AV geospatial data. Map management platform 562 can control access to the AV geospatial data, including granting or limiting access to the AV geospatial data based on user-based, role-based, group-based, task-based, and other attribute-based access control mechanisms. Map management platform 562 can provide version control for the AV geospatial data, such as to track specific changes that (human or machine) map editors have made to the data and to revert changes when necessary. Map management platform 562 can administer release management of the AV geospatial data, including distributing suitable iterations of the data to different users, computing devices, AVs, and other consumers of HD maps. Map management platform 562 can provide analytics regarding the AV geospatial data and related data, such as to generate insights relating to the throughput and quality of mapping tasks.

In some embodiments, the map viewing services of map management platform 562 can be modularized and deployed as part of one or more of the platforms and systems of the data center 550. For example, the AI/ML platform 554 may incorporate the map viewing services for visualizing the effectiveness of various object detection or object classification models, the simulation platform 556 may incorporate the map viewing services for recreating and visualizing certain driving scenarios, the remote assistance platform 558 may incorporate the map viewing services for replaying traffic incidents to facilitate and coordinate aid, the ridesharing platform 560 may incorporate the map viewing services into the client application 572 to enable passengers to view the AV 502 in transit en route to a pick-up or drop-off location, and so on.

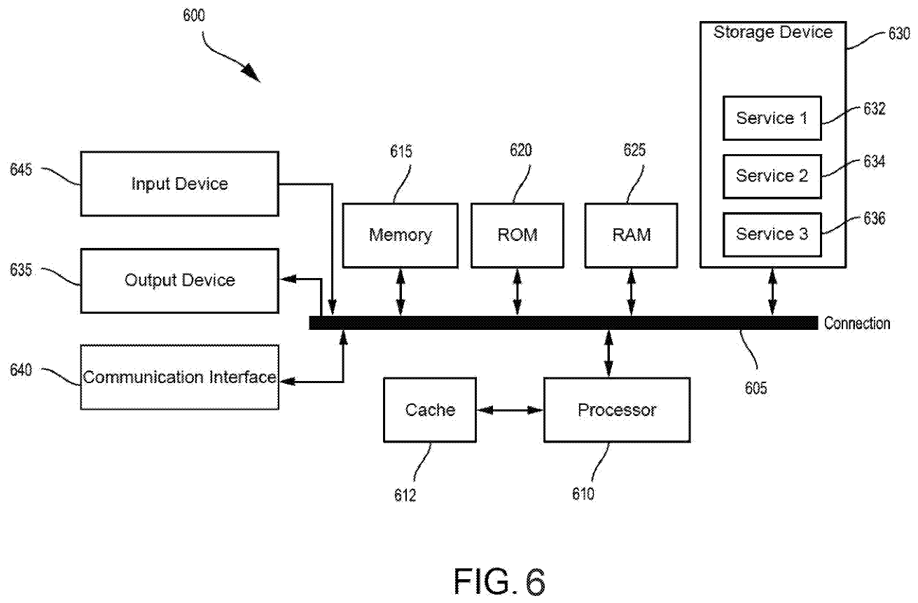

While the autonomous vehicle 502, the local computing device 510, and the autonomous vehicle environment 500 are shown to include certain systems and components, one of ordinary skill will appreciate that the autonomous vehicle 502, the local computing device 510, and/or the autonomous vehicle environment 500 can include more or fewer systems and/or components than those shown in FIG. 5. For example, the autonomous vehicle 502 can include other services than those shown in FIG. 5 and the local computing device 510 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 5. An illustrative example of a computing device and hardware components that can be implemented with the local computing device 510 is described below with respect to FIG. 6.

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECTED EXAMPLES

Illustrative examples of the disclosure include:
Aspect 1. A system comprising: at least one memory; and at least one processor coupled to the at least one memory, the at least one processor configured to: generate a power cycle event of an autonomous vehicle (AV); determine if a position of the AV is indicated after the power cycle event for initializing the AV; if the position of the AV is not indicated after the power cycle event, receive a second position from a wireless device; and initialize the AV based on the second position received from the wireless device.
Aspect 2. The system of Aspect 1, wherein the wireless device is an autonomous vehicle.
Aspect 3. The system of any of Aspects 1-2, wherein the wireless device is a survey sensor.
Aspect 4. The system of Aspect 3, wherein the survey sensor is attached to a fixed point location.
Aspect 5. The system of any of Aspects 1-4, wherein the position comprises at least one of a latitude, a longitude, an orientation, or a combination thereof.
Aspect 6. The system of any of Aspects 1-5, wherein the second position comprises at least one of a latitude of the wireless device, a longitude of the wireless device, or a combination thereof.
Aspect 7. The system of any of Aspects 1-6, wherein the second position comprises at least one of a latitude of the AV, a longitude of the AV, an orientation of the AV, or a combination thereof.
Aspect 8. A method comprising: generating a power cycle event of an autonomous vehicle (AV); determining if a position of the AV is indicated after the power cycle event for initializing the AV; if the position of the AV is not indicated after the power cycle event, receiving a second position from a wireless device; and initializing the AV based on the second position received from the wireless device.
Aspect 9. The method of Aspect 8, wherein the wireless device is an autonomous vehicle.
Aspect 10. The method of any of Aspects 8-9, wherein the wireless device is a survey sensor.
Aspect 11. The method of Aspect 10, wherein the survey sensor is attached to a fixed point location.
Aspect 12. The method of any of Aspects 8-11, wherein the position comprises at least one of a latitude, a longitude, an orientation, or a combination thereof.
Aspect 13. The method of and of Aspects 8-12, wherein the second position comprises at least one of a latitude of the wireless device, a longitude of the wireless device, or a combination thereof.
Aspect 14. The method of any of Aspects 8-13, wherein the second position comprises at least one of a latitude of the AV, a longitude of the AV, an orientation of the AV, or a combination thereof.
Aspect 15. A non-transitory computer-readable storage medium comprising at least one instruction for causing a computer or processor to: generate a power cycle event of an autonomous vehicle (AV); determine if a position of the AV is indicated after the power cycle event for initializing the AV; if the position of the AV is not indicated after the power cycle event, receive a second position from a wireless device; and initialize the AV based on the second position received from the wireless device.
Aspect 16. The non-transitory computer-readable storage medium of Aspect 15, wherein the wireless device is an autonomous vehicle.
Aspect 17. The non-transitory computer-readable storage medium of any of Aspects 15-16, wherein the wireless device is a survey sensor.
Aspect 18. The non-transitory computer-readable storage medium of Aspect 17, wherein the survey sensor is attached to a fixed point location.
Aspect 19. The non-transitory computer-readable storage medium of any of Aspects 15-18, wherein the position comprises at least one of a latitude, a longitude, an orientation, or a combination thereof.
Aspect 20. The non-transitory computer-readable storage medium of any of Aspects 15-19, wherein the second position comprises at least one of a latitude of the wireless device, a longitude of the wireless device, or a combination thereof.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A system comprising:
at least one memory; and
at least one processor coupled to the at least one memory, the at least one processor configured to:
generate a power cycle event of an autonomous vehicle (AV);
determine if a position of the AV is indicated after the power cycle event for initializing the AV;
if the position of the AV is not indicated after the power cycle event, receive a second position from a wireless device; and
initialize the AV based on the second position received from the wireless device.

2. The system of claim 1, wherein the wireless device is an autonomous vehicle.

3. The system of claim 1, wherein the wireless device is a survey sensor.

4. The system of claim 3, wherein the survey sensor is attached to a fixed point location.

5. The system of claim 1, wherein the position comprises at least one of a latitude, a longitude, an orientation, or a combination thereof.

6. The system of claim 1, wherein the second position comprises at least one of a latitude of the wireless device, a longitude of the wireless device, or a combination thereof.

7. The system of claim 1, wherein the second position comprises at least one of a latitude of the AV, a longitude of the AV, an orientation of the AV, or a combination thereof.

8. A method comprising:
generating a power cycle event of an autonomous vehicle (AV);
determining if a position of the AV is indicated after the power cycle event for initializing the AV;
if the position of the AV is not indicated after the power cycle event, receiving a second position from a wireless device; and
initializing the AV based on the second position received from the wireless device.

9. The method of claim 8, wherein the wireless device is an autonomous vehicle.

10. The method of claim 8, wherein the wireless device is a survey sensor.

11. The method of claim 10, wherein the survey sensor is attached to a fixed point location.

12. The method of claim 8, wherein the position comprises at least one of a latitude, a longitude, an orientation, or a combination thereof.

13. The method of claim 8, wherein the second position comprises at least one of a latitude of the wireless device, a longitude of the wireless device, or a combination thereof.

14. The method of claim 8, wherein the second position comprises at least one of a latitude of the AV, a longitude of the AV, an orientation of the AV, or a combination thereof.

15. A non-transitory computer-readable storage medium comprising at least one instruction for causing a computer or processor to:
generate a power cycle event of an autonomous vehicle (AV);
determine if a position of the AV is indicated after the power cycle event for initializing the AV;
if the position of the AV is not indicated after the power cycle event, receive a second position from a wireless device; and
initialize the AV based on the second position received from the wireless device.

16. The non-transitory computer-readable storage medium of claim 15, wherein the wireless device is an autonomous vehicle.

17. The non-transitory computer-readable storage medium of claim 15, wherein the wireless device is a survey sensor.

18. The non-transitory computer-readable storage medium of claim 17, wherein the survey sensor is attached to a fixed point location.

19. The non-transitory computer-readable storage medium of claim 15, wherein the position comprises at least one of a latitude, a longitude, an orientation, or a combination thereof.

20. The non-transitory computer-readable storage medium of claim 15, wherein the second position comprises at least one of a latitude of the wireless device, a longitude of the wireless device, or a combination thereof.
